(19) United States
(12) Patent Application Publication
(10) Pub. No.: US 2015/0240102 A1
(43) Pub. Date: Aug. 27, 2015

(54) LOW VISCOSITY AND HIGH LOADING SILVER NANOPARTICLES INKS FOR ULTRASONIC AEROSOL (UA)

(71) Applicant: XEROX CORPORATION, Norwalk, CT (US)

(72) Inventors: Ping Liu, Mississauga (CA); Yiliang Wu, Oakville (CA); Mahya Mokhtari, Etobicoke (CA); Naveen Chopra, Oakville (CA); Matthew A. Heuft, Oakville (CA); Rosa Duque, Brampton (CA)

(73) Assignee: XEROX CORPORATION, NORWALK, CT (US)

(21) Appl. No.: 14/188,335

(22) Filed: Feb. 24, 2014

(51) Int. Cl. C09D 11/00

(52) U.S. Cl. CPC C09D 11/52; Y10S 977/773; B82Y 35/00

(57) ABSTRACT

A low viscosity and a high loading silver nanoparticle conductive ink having at least about 50% weight of silver nanoparticles, a solvent having a viscosity equal to or less than about 1 cps, and a stabilizer. The conductive ink has a viscosity of less than about 5 cps and is suitable for an ultrasonic sprayer printing ink.

### TECHNICAL FIELD

This disclosure is generally directed to conductive inks. More specifically, this disclosure is directed to conductive inks having a high silver content and low viscosity for ultrasonic aerosol printing, and methods for producing such conductive inks.

### BACKGROUND

Conductive inks, such as silver nanoparticle inks, have great advantages for fabricating conductive patterns for electronic device applications through solution deposition processes. The silver nanoparticles may also be used to formulate conductive inks for other solution deposition processes including, for example, spin coating, dip coating, and aerosol printing.

Aerosol printing using an ultrasonic atomizer (UA printing) is a low cost and efficient printing process for manufacturing large numbers of electronic devices, such as RFID tags, antennas, and electronic sensors, etc.

However, UA printing usually requires a conductive ink having high loading of silver (>50% weight) and low viscosity (<5 cps). Unfortunately, achieving such a high silver content with low viscosity for the conductive silver nanoparticle inks is quite challenging.

Current conductive inks including high loading of silver nanoparticles of about 50-70% have a viscosity in the range of 8 to 12 cps. However, for Ultrasonic Aerosol ink printing applications, this viscosity range is not typically acceptable. UA printing typically needs a viscosity of less than 5 cps.

There remains a need for conductive inks with high silver loading (>50 wt %) and low viscosity (<5 cps) to meet the requirements of the UA printing for low cost electronic device applications.

### SUMMARY

The following detailed description is of the best currently contemplated modes of carrying out exemplary embodiments herein. The description is not to be taken in a limiting sense, but is made merely for the purpose of illustrating the general principles of the disclosure herein, since the scope of the disclosure herein is best defined by the appended claims.

Various inventive features are described below that can each be used independently of one another or in combination with other features.

Broadly, embodiments of the disclosure herein generally provide a low viscosity and a high loading silver nanoparticle conductive ink including at least about 50% weight of silver nanoparticles, a solvent having a viscosity equal to or less than about 1 cps, and a stabilizer.

In another aspect of the disclosure herein, a low viscosity and a high loading silver nanoparticle conductive ink including at least about 50% weight of silver nanoparticles, a solvent, and a stabilizer, wherein the conductive ink has a viscosity of less than about 5 cps.

In yet another aspect of the disclosure herein a low viscosity and a high loading silver nanoparticle conductive ink including at least about 50 weight percent of silver nanoparticles having an average size of from about 0.5 to about 100 nm, a solvent, and an organic stabilizer.

### DETAILED DESCRIPTION

In the present disclosure, the terms “a,” “an,” and “the” include plural forms unless the content clearly dictates otherwise.

In the present disclosure, all ranges disclosed herein include, unless specifically indicated, all endpoints and intermediate values.

In the present disclosure, the term “optional” or “optionally” refer, for example, to instances in which subsequently described circumstances may or may not occur, and include instances in which the circumstance occurs and instances in which the circumstance does not occur.

In the present disclosure, the phrases “one or more” and “at least one” refer, for example, to instances in which one of the subsequently described circumstances occurs, and to instances in which more than one of the subsequently described circumstances occurs.

In the present disclosure, the term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4.”

In the present invention, the term “nano” as used in “silver nanoparticles” refers to, for example, a particle size of less than about 100 nm, for example, from about 0.5 nm to about 100 nm, or from about 1 nm to about 50 nm, or from about 1 nm to about 20 nm. The particle size refers to the average diameter of the metal particles, as determined by transmission electron microscopy (TEM) or other suitable method.

In the present disclosure, the term “printing” refers to any coating technique capable of forming the conductive ink into a desired pattern on the substrate. Examples of suitable techniques include, for example, aerosol printing such as ultrasonic aerosol printing (UA).

The present disclosure provides inks including a high silver loading (>50% weight) and low viscosity (<5 cps) for UA printing. The ink includes at least about 50% weight of silver nanoparticles, a stabilizer, and a solvent having a viscosity of equal to or less than about 1 cps. The present disclosure also provides methods for producing such inks.

The inks may be made by any suitable method. One exemplary method is to dissolve stabilized silver nanoparticles with a solvent by gently rolling and shaking. The silver ink dispersion is then filtered with a micro filter.

The inks can be used to form conductive features on a substrate by printing. The printing may be carried out by depositing the ink on a substrate using any suitable printing technique, for example, UA printing. In the UA printing process, an ultrasonic transducer device is used to create a fine aerosol mist of ink droplets that is pumped through a nozzle.

The substrate upon which the ink is deposited may be any suitable substrate including, for example, silicon, glass plate, plastic film, sheet, fabric, or paper. For structurally flexible devices, plastic substrates such as polyester, polycarbonate, polyimide sheets and the like may be used.

Following printing, the patterned deposited conductive paste ink can be subjected to a curing step. The curing step can be a step in which substantially all of the solvent of the conductive paste ink is removed and the ink is firmly adhered to the substrate.

### Silver Nanoparticles

According to embodiments herein, the silver nanoparticles may have diameter in the submicron range. Silver nanoparticles herein may have unique properties when compared to silver flakes. For example, the silver nanoparticles herein may be characterized by enhanced reactivity of the surface atoms, high electric conductivity, and unique optical properties. Further, the silver nanoparticles may have a lower melting point and a lower sintering temperature than silver flakes. Due to their small size, silver nanoparticles exhibit a melting point as low as 1000° C. below silver flakes. For example, silver nanoparticles may sinter at 120° C. which is more than 800° C. below the melting temperature of bulk silver. This lower melting point is a result of comparatively high surface-area-to-volume ratio in nanoparticles, which allows bonds to readily form between neighboring particles. The large reduction in sintering temperature for nanoparticles enables forming highly conductive traces or patterns on flexible plastic substrates, because the flexible substrates of choice melt or soften at relatively low temperatures (for example, 150° C.).

The silver nanoparticles herein may be elemental silver, a silver alloy, a silver compound, or combination thereof. In embodiments, the silver nanoparticles may be a base material coated or plated with pure silver, a silver alloy, or a silver compound. For example, the base material may be copper flakes with silver plating.

Examples of the silver compound herein may include silver oxide, silver thiocyanate, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate and derivatives thereof. The silver alloy may be formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr and Ba, but not particularly limited to them.

In embodiments, the silver compound may include either or both of (i) one or more other metals and (ii) one or more non-metals. Suitable other metals include, for example, Al, Au, Pt, Pd, Cu, Co, Cr, In, and Ni, particularly the transition metals, for example, Au, Pt, Pd, Cu, Cr, Ni, and mixtures thereof. Exemplary metal composites includes Au—Ag, Ag—Cu, Au—Ag—Cu, and Au—Ag—Pd. Suitable non-metals in the metal composite include, for example, Si, C, and Ge.

In embodiments, the silver nanoparticles may be elemental silver.

The silver nanoparticles herein may have an average particle size, for example, from about 0.5 to about 100 nm, or from about 1.0 to about 50.0 microns, or from about 1.0 to about 20.0 microns.

The use of nano-sized silver nanoparticles results in thin and uniform films with high conductivity and low surface roughness, which is important for multilayer electronic device integration.

The silver nanoparticles may have any shape or geometry. In certain embodiments, the silver nanoparticles may have a spherical shape.

The silver nanoparticles may be present in the conductive ink in an amount, for example, at least about 50 weight percent of the conductive ink, or from about 50 to about 90 weight percent of the conductive ink, or from about 55 to about 85 weight percent of the conductive ink.

In embodiments, the silver nanoparticles have a stability (that is, the time period where there is minimal precipitation or aggregation of the nanoparticles of, for example, at least about 1 day, or from about 3 days to about 1 week, or from about 5 days to about 1 month, or from about 1 week to about 6 months, or from about 1 week to over 1 year.

### Stabilizer(s)

The conductive ink herein may include a stabilizer(s). One or more stabilizers, such as organoamines or other stabilizers, may be attached to the surface of the silver nanoparticles to form the stabilized silver-containing nanoparticles. The stabilizer(s) may minimize or prevent the silver-containing nanoparticles from agglomerating and/or optionally providing the solubility or dispersibility of silver-containing nanoparticles.

The stabilizer(s) may interact with the silver-containing nanoparticles by a chemical bond and/or a physical attachment. The chemical bond may take the form of, for example, covalent bonding, hydrogen bonding, coordination complex bonding, or ionic bonding, or a mixture of different chemical bondings. The physical attachment may take the form of, for example, van der Waals' forces or dipole-dipole interaction, or a mixture of different physical attachments.

In addition, the stabilizer(s) may be thermally removable, which means that the stabilizer(s) may disassociate from the silver-containing nanoparticle surface under certain conditions, such as through heating or annealing.

Suitable stabilizers may include one or more organic stabilizers. Exemplary organic stabilizers can include thiol and its derivatives; amine and its derivatives; carboxylic acid and its carboxylate derivatives; polyethylene glycols; and other organic surfactants. In embodiments, the organic stabilizer can be selected from the group consisting of a thiol such as for example butanethiol, pentanethiol, hexanethiol, heptanethiol, octanethiol, decanethiol, and dodecanethiol; an amine such as for example ethylamine, propylamine, butylamine, penylamine, hexylamine, heptylamine, octylamine, nonylamine, decylamine, and dodecylamine; a dithiol such as for example 1,2-ethanedithiol, 1,3-propanedithiol, and 1,4-butanedithiol; a diamine such as for example ethylenediamine, 1,3-diaminopropane, 1,4-diaminobutane; a mixture of a thiol and a dithiol; and a mixture of an amine and a diamine. In addition, the organic stabilizer(s) may include pyridine derivatives, for example, dodecyl pyridine and/or organophosphine.

In addition, the stabilizer may be an organoamine including, for example, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, N,N-dimethylamine, N,N-dipropylamine, N,N-dibutylamine, N,N-dipentylamine, N,N-dihexylamine, N,N-diheptylamine, N,N-dioctylamine, N,N-dinonylamine, N,N-didecylamine, N,N-diundecylamine, N,N-didodecylamine, methylpropylamine, ethylpropylamine, propylbutylamine, ethylbutylamine, ethylpentylamine, propylpentylamine, butylpentylamine, triethylamine, tripropylamine, tributylamine, tripentylamine, trihexylamine, triheptylamine, trioctylamine, 1,2-ethylenediamine, N,N,N′,N′-tetramethylethylenediamine, propane-1,3-diamine, N,N,N′,N′-tetramethylpropane-1,3-diamine, butane-1,4-diamine, and N,N,N′,N′-tetramethylbutane-1,4-diamine, and the like, or mixtures thereof. In specific embodiments, the silver nanoparticles are stabilized with dodecylamine, tridecylamine, tetradecylamine, pentadecylamine, or hexadecylamine.

### Solvent(s)

The conductive ink herein may also include a solvent(s). The solvent(s) may be used as a vehicle for dispersion of the silver nanoparticles to minimize or prevent the silver nanoparticles from agglomerating and/or optionally providing or enhancing the solubility or dispersiblity of silver nanoparticles.

To formulate the low viscosity (<5 cps) and high silver loading (>50% wt) required by UA printing, solvent(s) used in the conductive ink herein may have a viscosity equal to or less than about 1 cps. In addition, the solvent(s) can have good miscibility with the silver nanoparticles.

Any suitable solvent(s) having a viscosity equal to or less than about 1 cps may be used to dissolve or to disperse the silver nanoparticle for the ink herein. Examples of suitable solvents may include organic solvents, for example, a hydrocarbon, a heteroatom-containing aromatic compound, or an alcohol.

Not all hydrocarbons, heteroatom-containing aromatic compounds, and alcohols necessarily have a viscosity equal to or less than about 1 cps.

Solvent(s) having a viscosity equal to or less than about 1 cps may generate drops suitable for use on UA printing It was found that once the solvent(s) viscosity increases beyond 5-10 cps, the aerosol output drops dramatically. Ultrasonic aerosol printing using higher viscosity solvents requires either higher ultrasonic energy or heating of the solvent (to reduce the viscosity). Heating is not preferred, as the nanoparticle may be destabilized, or condensation of the heated aerosol can occur in the delivery lines as the aerosol cools down.

Suitable organic solvent(s) herein may be, for example, cyclohexane, n-octane, toluene, m-xylene, o-xylene, p-xylene, mesitylene, isopar, heptane, isooctane, and trimethylbenzene. These types of solvents have very low viscosity property (equal to or less than about 1 cps) and good solubility for silver nanoparticles.

Table 1 includes a list of examples of suitable organic solvents herein having a viscosity equal to or less than about 1 cps.

TABLE 1

| | | mol. | | |
|---|---|---|---|---|
| | molecular | weight | viscosity | |
| Organic Solvent | formula | g/mol | (cPs) | |
| Cyclopentene | C₅H₈ | 68.12 | 0.233 | [25° C.] |
| 2,4,4-Trimethyl-l -pentene | C₈H₁₆ | 112.2 | 0.295 | [25° C.] |
| 2,4,4-Trimethyl-2-pentene | C₈H₁₆ | 112.2 | 0.298 | [25° C.] |
| Dimethoxymethane | C₃H₈O₂ | 76.1 | 0.335 | [25° C.] |
| Acrylonitrile | C₃H₃N | 53.1 | 0.34 | [25° C.] |
| Methyl ethyl ketone | C₄H₈O | 72.12 | 0.378 | [25° C.] |
| n-Heptane | C₇H₁₆ | 100.23 | 0.397 | [25° C.] |
| | | | 0.42 | [20° C.] |
| | | | 0.378 | [26.9° C.] |
| Vinyl acetate | C₄H₆O₂ | 86.1 | 0.403 | [25° C.] |
| tert-Amyl Methyl Ether | C₆H₁₄O | 102 | 0.42 | [20° C.] |
| Ethyl acetate | C₄H₈O₂ | 88.12 | 0.426 | [25° C.] |
| Crotonaldehyde | C₄H₆O | 70.1 | 0.428 | [25° C.] |
| 1-Chlorobutane | C₄H₉Cl | 92.6 | 0.43 | [25° C.] |
| Methyl propionate | C₄H₈O₂ | 88.12 | 0.43 | [25° C.] |
| Butyraldehyde | C₄H₈O | 72.1 | 0.43 | [25° C.] |
| Methyl isopropyl ketone | C₅H₁₀O | 86.15 | 0.43 | [25° C.] |
| 1-Octene | C₈H₁₆ | 112.2 | 0.441 | [25° C.] |
| 1,2-Dimethoxyethane | C₄H₁₀O₂ | 90.12 | 0.455 | [25° C.] |
| 3-Pentanone | C₅H₁₀O | 86.1 | 0.47 | [20° C.] |
| 2,2,4-Trimethyl pentane | C₈H₁₈ | 114.3 | 0.475 | [25° C.] |
| Methyl propyl ketone | C₅H₁₀O | 86.15 | 0.489 | [20° C.] |
| Acetic acid, isopropyl ester | C₅H₁₀O2 | 102.15 | 0.52 | [25° C.] |
| n-Octane | C₈H₁₈ | 114.22 | 0.546 | [20° C.] |
| | | | 0.51 | [26.9° C.] |
| Methyl isobutyl ketone | C₆H₁₂O | 100.18 | 0.5463 | [25° C.] |
| Fluorobenzene | C₆H₅F | 96.1 | 0.55 | [25° C.] |
| n-Propyl acetate | C₅H₁₀O₂ | 102.13 | 0.551 | [25° C.] |
| Toluene | C₇H₈ | 92.15 | 0.5525 | [25° C.] |
| | | | 0.59 | [20° C.] |
| 1-Chloropentane | C₅H₁₁Cl | 106.6 | 0.559 | [25° C.] |
| Ethyl chloroformate | C₃H₅ClO₂ | 108.53 | 0.56 | [25° C.] |
| tert-Butyl acetate | C₆H₁₂O₂ | 116.16 | 0.57 | [25° C.] |
| Methyl isobutenyl ketone | C₆H₁₀O | 98.16 | 0.58 | [25° C.] |
| m-Xylene | C₈H₁₀ | 106.18 | 0.581 | [25° C.] |
| | | | 0.62 | [20° C.] |
| Dimethyl carbonate | C₃H₆O₃ | 90.08 | 0.585 | [25° C.] |
| 1,1,2-Trichloroethylene | C₂HCl₃ | 131.38 | 0.592 | [20° C.] |
| Dibutyl ether | C₈H₁₈O | 130.26 | 0.602 | [30° C.] |
| p-Xylene | C₈H₁₀ | 106.18 | 0.605 | [25° C.] |
| | | | 0.65 | [20° C.] |
| Nitromethane | CH₃NO₂ | 61.04 | 0.61 | [25° C.] |
| Ethylbenzene | C₈H₁₀ | 106.18 | 0.6373 | [25° C.] |
| Nitroethane | C₂H₅NO₂ | 75.1 | 0.64 | [25° C.] |
| 1-Cyanobutane | C₅H₉N | 83.13 | 0.69 | [25° C.] |
| Methyl isoamyl ketone | C₇H₁₄O | 114.21 | 0.7 | [25° C.] |
| Isobutyl acetate | C₆H₁₂O₂ | 116.16 | 0.709 | [20° C.] |
| Methyl tert-butyl ketone | C₆H₁₂O | 100.1 | 0.71 | [25° C.] |
| n-Butyl acetate | C₆H₁₂O₂ | 116.18 | 0.737 | [20° C.] |
| 2-Picoline | C₆H₇N | 93.1 | 0.75 | [25° C.] |
| 1,2-Dichloropropane | C₃H₆Cl₂ | 113 | 0.75 | [25° C.] |
| o-Xylene | C₈H₁₀ | 106.18 | 0.756 | [25° C.] |
| | | | 0.81 | [20° C.] |
| Acetyl acetone | C₅H₈O₂ | 100.13 | 0.767 | [25° C.] |
| 2-Nitropropane | C₃H₇NO₂ | 89.1 | 0.77 | [20° C.] |
| 1,2-Dichloroethane | C₂H₄Cl₂ | 98.96 | 0.78 | [25° C.] |
| Cyclohexane | C₆H₁₂ | 84.16 | 0.93 | [22° C.] |
| Mesitylene | C₉H₁₂ | 120.19 | 0.70 | [20° C.] |
| 1-Nitropropane | C₃H₇NO₂ | 89.1 | 0.79 | [25° C.] |
| o-Chlorotoluene | C₇H₇Cl | 126.59 | 0.8 | [38° C.] |
| p-Chlorotoluene | C₇H₇Cl | 126.59 | 0.834 | [25° C.] |
| 1,4-Dichlorobenzene | C₆H₄Cl₂ | 147 | 0.84 | [55° C.] |
| 3-Picoline | C₆H₇N | 93.1 | 0.87 | [25° C.] |
| 4-Picoline | C₆H₇N | 93.1 | 0.87 | [25° C.] |
| 1,1,2,2-Tetrachloroethylene | C₂Cl₄ | 165.82 | 0.903 | [20° C.] |
| d-Limonene | C₁₀H₁₆ | 136.26 | 0.923 | [25° C.] |
| Cyclooctane | C₈H₁₆ | 144 | 0.972 | [25° C.] |

The solvent may be present in the conductive ink in an amount, for example, from about 2.0 to about 50.0 weight percent of the conductive ink, or from about 5.0 to about 40.0 weight percent of the conductive ink, or from about 10.0 to about 30.0 weight percent of the conductive ink.

### EXAMPLE

The following Example illustrates one exemplary embodiment of the present disclosure. This Example is intended to be illustrative only to show one of several methods of preparing the inks and is not intended to limit the scope of the present disclosure. Also, parts and percentages are by weight unless otherwise indicated.

### Example 1

### Control

A silver nanoparticle ink with 65 wt % silver nanoparticle ink was prepared in a mixture of organic solvents including decahydronaphthalene (decalin) and dicylcohexyl (2/1 by wt.). The mixture was prepared as follows: 51.1 g of organoamine stabilized silver nanoparticles was dissolved in 12.6 g of decalin and 6.3 g of dicyclohexyl by gently rolling and shaking for about 48 hours. The final silver ink was obtained after filtration with a syringe filter (3.1 um). The resulting silver nanoparticle ink contained high silver content of 65 wt %, which was determined by removing all the solvents and organic stabilizer at a hot plate (250° C.) for 5 min.

The viscosity of the ink was about 12 cps and the conductivity of a spin-coated film on a glass slide (1 inch by 2 inch) was 2.38×10⁴ S/cm, measured by 4 point probe conductivity measurement. As can be seen, a silver nanoparticle ink with a silver content of 65 wt % shows high viscosity of about 12 cps when using organic solvent(s) having a viscosity of more than 1 cps, which is not suitable for UA printing.

### Examples 2 and 3

High loading silver content of silver nanoparticle inks with toluene and m-xylene having viscosity less than 1 cps results in low ink viscosity of about 2.5 to 3.0 cps, respectively

Two silver nanoparticle inks with high silver content loadings (65 wt % (Example 2) and 69 wt % (Example 3)) were prepared relatively in mixed solvents including toluene and m-xylene which have low viscosity of less than 1 cps. They were prepared in a similar manner by dissolving the same kind of organoamine stabilized silver nanoparticles used in example 1 (comparable example) in the mixed organic solvents by rolling and shaking for about 48 hours. The results were summarized in Table 2.

Table 2 shows a summary of ink properties with ink formulations containing toluene and m-xylene.

TABLE 2

| Sample ID | Example 2 | Example 3 |
|---|---|---|
| Solvents | Toluene (80 wt %), | m-xylene (80 wt %), |
| | Decalin (10 wt %), | Decalin(10 wt %), |
| | Dicyclohexyl (10 wt %) | Dicyclohexyl(10 wt %) |
| Results | Viscosity: 2.6 cps | Viscosity: 3.0 cps |
| | Silver content: 65 wt % | Silver Content: 69 wt % |

### Examples 4, 5, and 6

High loading silver content of silver nanoparticle inks with mesitylene having viscosity less than 1 cps results in low ink viscosity in the range of about 2 to 4 cps.

Three silver nanoparticle inks with high silver content loadings (63 to 65 wt %) were prepared in mixed solvents including mesitylene which has low viscosity of less than 1 cps. They were prepared in a similar manner as the ink samples prepared in Example 2 by dissolving the same kind of organoamine stabilized silver nanoparticles used in Example 2 in the mixed organic solvents by rolling and shaking for about 48 hours.

Table 3 summarizes the results of Examples 4-6.

TABLE II

| Sample ID | Example 4 | Example 5 | Example 6 |
|---|---|---|---|
| Solvents | Decalin | Dicyclohexyl | Decalin |
| | (60 wt %), | (60 wt %) | (48 wt %), |
| | Mesitylene | Mesitylene | Dicyclohexyl |
| | (40 wt %) | (40 wt %) | (12 wt %), |
| | | | Mesitylene |
| | | | (40 wt %) |
| Results | Viscosity: | Viscosity: | Viscosity: |
| | 2.1 cps | 4.2 cps | 2.3 cps |
| | Silver Content: | Silver Content: | Silver Content: |
| | 65 wt % | 63% | 63 wt % |

As can be seen from Table 3, all of the conductive inks of Examples 4-6 have good electrical properties and high printing throughput up to 11 mg/min.

Table 4 summarizes compositions containing blends of low viscosity solvents to furnish high silver content inks with low viscosity, suitable for ultrasonic aerosol ink printing.

TABLE 4

| | Solvent | Ag content | Viscosity (cps) at |
|---|---|---|---|
| Ink ID | Composition | (%) | 400 s⁻¹ |
| Example 1 | 66% decalin | 65 | 12 |
| (Control) | 34% bicyclohexyl | | |
| Example 2 | 80% toluene | 65 | 2.5 |
| | 10% decalin | | |
| | 10% bicyclohexyl | | |
| Example 3 | 80% mesitylene | 69 | 3.0 |
| | 10% decalin | | |
| | 10% bicyclohexyl | | |
| Example 4 | 40% mesitylene | 65 | 2.1 |
| | 60% decalin | | |
| Example 5 | 40% mesitylene | 63 | 4.2 |
| | 60% bicylohexyl | | |
| Example 6 | 40% mesitylene | 63 | 2.3 |
| | 48% decalin | | |
| | 12% bicyclohexyl | | |

As can be seeing from Table 4, the ink compositions according to the present disclosure produce conductive inks with low viscosity (<5 cps), suitable for ultrasonic aerosol ink printing.

The low viscosity and a high loading silver nanoparticle conductive ink according to the present disclosure may have a sheet resistivity of up to about 2 Ω/sq.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

What is claimed is:

1. A low viscosity and a high loading silver nanoparticle conductive ink comprising:
at least about 50% weight of silver nanoparticles;
a solvent having a viscosity equal to or less than about 1 cps; and
a stabilizer.

2. The conductive ink according to claim 1, wherein the silver nanoparticles have an average size of from about 0.5 to about 100 nm.

3. The conductive ink according to claim 1, wherein the silver nanoparticles are selected from the group consisting of elemental silver, silver alloys, silver oxides, silver thiocyanates, silver cyanides, silver cyanates, silver carbonates, silver nitrates, silver nitrites, silver sulfates, silver phosphates, silver perchlorates, silver tetrafluoroborates, silver acetylacetonates, silver acetates, silver lactates, silver oxalates, and silver alloys formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr, and Ba.

4. The conductive ink according to claim 1, wherein the silver nanoparticles comprise elemental silver.

5. A low viscosity and a high loading silver nanoparticle conductive ink comprising:
at least about 50% weight of silver nanoparticles;
a solvent;
a stabilizer; and
wherein the conductive ink has a viscosity of less than about 5 cps.

6. The conductive ink according to claim 5, wherein the solvent has a viscosity equal to or less than about 1 cps.

7. The conductive ink according to claim 5, wherein the solvent is selected from the group consisting of toluene, xylene, isopar, trimethylbenzene, heptane, isosoctane, and mixtures thereof.

8. The conductive ink according to claim 5, wherein the solvent includes two or more non-polar organic solvents.

9. The conductive ink according to claim 5, wherein the solvent comprises an amount of from about 2.0 to about 50.0 weight percent of the conductive ink.

10. A low viscosity and a high loading silver nanoparticle conductive ink comprising:
at least about 50 weight percent of silver nanoparticles having an average size of from about 0.5 to about 100 nm;
a solvent; and
an organic stabilizer.

11. The conductive ink according to claim 10, wherein the solvent has a viscosity equal to or less than about 1 cps.

12. The conductive ink according to claim 10, wherein the solvent comprises an organic solvent.

13. The conductive ink according to claim 10, wherein the solvent is selected from the group consisting of toluene, xylene, isopar, trimethylbenzene, heptane, isosoctane, and mixtures thereof.

14. The conductive ink according to claim 10, wherein the silver nanoparticles comprise elemental silver.

15. The conductive ink according to claim 10, wherein the silver nanoparticles comprise an amount of from about 50 to about 90 weight percent of the conductive ink.

16. The conductive ink according to claim 10, wherein the stabilizer is selected from the group consisting of thiol and its derivatives; amine and its derivatives; carboxylic acid and its carboxylate derivatives; and polyethylene glycols.

17. The conductive ink according to claim 10, wherein the conductive ink has a viscosity of less than about 5 cps.
